(19) United States
(12) Patent Application Publication
(10) Pub. No.: US 2022/0269252 A1
(43) Pub. Date: Aug. 25, 2022

(54) METHOD, APPARATUSES, COMPUTER PROGRAM AND MEDIUM INCLUDING COMPUTER INSTRUCTIONS FOR PERFORMING INSPECTION OF AN ITEM

(71) Applicant: OMRON Corporation, Kyoto-shi, Kyoto (JP)

(72) Inventors: Hiroyuki MIYAURA, Kyoto-shi, Kyoto (JP); Masaki SUWA, Kyoto-shi, Kyoto (JP)

(21) Appl. No.: 17/629,685

(22) PCT Filed: Aug. 11, 2020
(86) PCT No.: PCT/IB2020/057536

§ 371 Date: Jan. 24, 2022

(30) Foreign Application Priority Data
Aug. 13, 2019 (IB) PCT/IB2019/056861

(51) Int. Cl. G05B 19/418

(52) U.S. Cl. CPC G05B 19/41875; G05B 2219/32368

(57) ABSTRACT

It is provided a method (and corresponding apparatuses, computer programs, and medium) for determining whether an item being processed is defective or non-defective, the method including a step of determining, by a local neural network and on the basis of sensing measurements performed on an item while the item is being processed, a local classification result indicating whether the item is defective or non-defective. It is determined a confidence index indicating a level of confidence that the local classification result is correct. Then, in response to the confidence index being below a given threshold, it is determined, by a central neural network and on the basis of the sensing measurements, a central classification result indicating whether the item is defective or non-defective, wherein the local neural network has less computational resources than the central neural network.

### FIELD OF THE INVENTION

The invention relates to methods, devices, computer programs and medium comprising computer instructions for performing inspections of an item, in particular for determining whether an item being processed is defective or non-defective.

### TECHNICAL BACKGROUND

Visual inspection devices are used on manufacturing lines to check whether a product being manufactured is defective or not. Such devices typically comprise an image sensor like a camera, a memory and a CPU to perform image processing and general processing. These devices are sufficiently small to be installed on a component (e.g. a robot) of the manufacturing line, and work only locally for a number or reasons, like having a quick response time, avoiding communication problems with other devices, keeping their construction and installation as simple as possible, etc. Different image processing techniques are available for determining whether a picture refers to a defective or non-defective product, each of such techniques suitable for respective applications or use scenarios, and each characterized by certain errors and corresponding computational complexity.

Furthermore, there are other types of inspection systems, not necessarily based on a visual analysis but based instead for instance on measuring parameters of the actual product to determine if the same is defective or not.

However, known techniques may be subject to errors and/or require large processing capabilities.

### SUMMARY OF THE INVENTION

One of the objects of the present invention lies therefore in improving existing systems for performing inspections, and/or overcoming at least some of the problems existing in prior art solutions.

The object is achieved by:
According to aspect A1, it is provided an inspection method for determining whether an item being processed is defective or non-defective, the method including the steps of:

determining (S10), by a local neural network (11) and on the basis of sensing measurements performed on an item while the item is being processed, a local classification result indicating whether the item is defective or non-defective;

determining (S20) a confidence index indicating a level of confidence that the local classification result is correct;

in response to the confidence index being below a given threshold, determining (S30), by a central neural network (21) and on the basis of the sensing measurements, a central classification result indicating whether the item is defective or non-defective, wherein the local neural network (11) has less computational resources than the central neural network (21).
A2. In the method according to aspect A1, the confidence index is determined when training the local neural network (11) and wherein the given threshold is determined empirically, preferably when training the local neural network (11).
A3. In the method according to aspect A1 and/or A2, the confidence index is determined by correlating an actual activation pattern exhibited by a plurality of nodes of the local neural network (11) when determining the local classification result with a reference activation pattern exhibited by said plurality of nodes of the local neural network (11) while training the local neural network (11), and wherein
the given threshold includes a correlation threshold indicating a predetermined level of correlation.
A4. In the method according to any of the preceding aspects, the confidence index is determined by correlating at least one feature vector obtained by the local neural network (11) while determining the classification result with at least one respective reference feature vector obtained by the local neural network (11) while training the local neural network (11).
According to aspect A5, it is provided an inspection device (10) for determining whether an item being processed is defective or non-defective, the local inspection device (10) comprising:

a local neural network (11) configured to determine, on the basis of sensing measurements performed on an item while the item is being processed, a local classification result indicating whether the item is defective or non-defective;

a processor (12) configured to determine a confidence index indicating a level of confidence that the local classification result is correct;

an output section (13) configured to output, in response to the confidence index being below a given threshold, a central classification indication notification notifying that a central classification result indicating whether an item being processed is defective or non-defective is to be performed by a central neural network, wherein the local neural network has less computational resources than the central neural network (21).
A6. In the local inspection device (10) of aspect A5, the central classification indication notification includes a request to determine the central classification result by a central neural network, and wherein the output section (13) is configured to send the request to a central inspection device (20) including the central neural network (21).
A7. In the inspection device according to aspect A5 or A6, the confidence index is determined when training the local neural network (11) and wherein the given threshold is determined empirically, preferably when training the local neural network (11).
A8. In the inspection according to any of aspects A5 to A7, the confidence index is determined by correlating an actual activation pattern exhibited by a plurality of nodes of the local neural network (11) when determining the local classification result with a reference activation pattern exhibited by said plurality of nodes of the local neural network (11) while training the local neural network (11), and wherein
the given threshold includes a correlation threshold indicating a predetermined level of correlation.
A9. In the method according to any of aspects A5 to A8, the confidence index is determined by correlating at least one feature vector obtained by the local neural network (11) while determining the classification result with at least a respective reference feature vector obtained by the local neural network (11) while training the local neural network (11).
According to aspect A10, it is provided an inspection device (20) for determining whether an item being processed is defective or non-defective, the inspection device (20) including:

a central neural network (21) configured to
determine, on the basis of sensing measurements performed on an item while the item is being processed, a classification result indicating whether the item is defective or non-defective,
a receiver (22) configured to receive an instruction to perform the central classification, the instruction indicating that a local neural network (11) determined a classification result on the basis of the sensing measurements with a confidence level below a given threshold, wherein the local neural network (11) has less computational resources than the central neural network (21).
A11. In the inspection device of aspect A10, the central inspection device (20) is configured to operate the central neural network (2021) by using more computational resources than those available at the local neural network.
A12. In the inspection device of aspect A10 or A11, the confidence index is determined when training the local neural network (11) and wherein the given threshold is determined empirically, preferably when training the local neural network (11).
A13. In the inspection device of any of aspects A10 to A12, the confidence index is determined by correlating an activation pattern exhibited by a plurality of nodes of the local neural network (11) when determining the local classification result with a reference activation pattern exhibited by said plurality of nodes of the local neural network (11) while training the local neural network (11), and wherein
the given threshold includes a correlation threshold indicating a predetermined level of correlation.
A14. In the inspection device of any of aspects A10 to A13, the confidence index is determined by correlating at least one feature vector obtained by the local neural network (11) while determining the classification result with at least a respective reference feature vector obtained by the local neural network (11) while training the local neural network (11).
According to aspect A15, it is provided an inspection system for determining, on the basis of sensing measurements performed on an item while the item is being processed, whether the item is defective or non-defective by using at least one of a local neural network (11) and a central neural network (21), wherein the local neural network has less computational resources than the central neural network, wherein
in response to a determination that a local confidence index is not above a predetermined confidence level, the local confidence index indicating a level of confidence that the local classification result is correct, the central neural network (21) is configured to determine a central classification result indicating whether the obtained sensing measurements represent a defective item or a non-defective item, and wherein
the central classification result is made the classification result of the system.
A16. In the inspection system of aspect A15, the confidence index is determined when training the local neural network (11) and wherein the given threshold is determined empirically, preferably when training the local neural network (11).
A17. In the inspection system of aspect A15 or A16, the confidence index is determined by correlating an activation pattern exhibited by a plurality of nodes of the local neural network (11) when determining the local classification result with a reference activation pattern exhibited by said plurality of nodes of the local neural network (11) while training the local neural network (11), and wherein
the given threshold includes a correlation threshold indicating a predetermined level of correlation.
A18. In the inspection system of any of aspects A15 to A17, the confidence index is determined by correlating at least one feature vector obtained by the local neural network (11) while determining the classification result with at least a respective reference feature vector obtained by the local neural network (11) while training the local neural network (11).
According to aspect A19, it is provided a computer program comprising instructions configured to execute, when said instructions are executed on a computer, the steps of any of aspects A1 to A4.
According to aspect A20, it is provided an inspection method for determining whether an item being processed is defective or non-defective, the method including the steps of determining (S10), by a neural network (11) and on the basis of sensing measurements performed on an item while the item is being processed, a classification result indicating whether the item is defective or non-defective; determining (S20) a confidence index indicating a level of confidence that the classification result is correct; in response to the confidence index being below a given threshold, outputting (S30) a notification message notifying that a classification result indicating whether the item is defective or non-defective has a level of confidence below a given level.
A21. The method of aspect A20, wherein the notification message is output to a device for notification and/or to a device for further processing. A22. The method according to aspects A20 or A21, wherein the confidence index is determined when training the neural network (11) and wherein the given threshold is determined empirically, preferably when training the neural network (11).
A23. The method according to any of aspects A20 to A22, wherein the confidence index is determined by correlating an actual activation pattern exhibited by a plurality of nodes of the neural network (11) when determining the classification result with a reference activation pattern exhibited by said plurality of nodes of the neural network (11) while training the neural network (11), and wherein the given threshold includes a correlation threshold indicating a predetermined level of correlation.
A24. The method according to any of aspects A20 to A23, wherein the confidence index is determined by correlating at least one feature vector obtained by the neural network (11) while determining the classification result with at least one respective reference feature vector obtained by the neural network (11) while training the neural network (11), wherein the one feature vector obtained by the neural network preferably includes a vector containing feature parameters obtained by at least one node of one or more layers of the neural network (11).
A25. An inspection device (10) for determining whether an item being processed is defective or non-defective, the inspection device (10) comprising: a neural network (11) configured to determine, on the basis of sensing measurements performed on an item while the item is being processed, a classification result indicating whether the item is defective or non-defective; a processor (12) configured to determine a confidence index indicating a level of confidence that the classification result is correct; an output section (13) configured to output, in response to the confidence index being below a given threshold, a notification message notifying that a result indicating whether an item being processed is defective or non-defective has a level of confidence below a given level.
A26. The inspection device (10) of aspect A25, wherein the output section (13) is further configured to output the notification message to a device for notification and/or to a device for further processing.
A27. The inspection device (10) according to aspect A25 or A26, wherein the confidence index is determined when training the neural network (11) and wherein the given threshold is determined empirically, preferably when training the neural network (11).
A28. The inspection device (10) according to any of aspects A25 to A27, wherein the confidence index is determined by correlating an actual activation pattern exhibited by a plurality of nodes of the neural network (11) when determining the classification result with a reference activation pattern exhibited by said plurality of nodes of the neural network (11) while training the neural network (11), and wherein the given threshold includes a correlation threshold indicating a predetermined level of correlation.
A29. The inspection device (10) according to any of aspects A25 to A28, wherein the confidence index is determined by correlating at least one feature vector obtained by the neural network (11) while determining the classification result with at least a respective reference feature vector obtained by the neural network (11) while training the neural network (11).
A30. A computer program comprising instructions configured to execute, when said instructions are executed on a computer, the steps of any of aspects A1 to A5 or any of aspects A20 to A24.
A31. Medium comprising instructions configured to execute, when said instructions are executed on a computer, the steps of any of aspects A1 to A5 or any of aspects A20 to A24.

### BRIEF DESCRIPTION OF FIGURES

FIG. 1 is flow chart illustrating a method according to an embodiment of the present invention;

FIG. 2 shows a block diagram of a device according to one embodiment of the present invention;

FIG. 3 shows a block diagram of a device according to one embodiment of the present invention;

FIG. 4 shows a block diagram of a system according to one embodiment of the present invention;

FIG. 5 shows a block diagram of a computer suitable for executing instructions according to one embodiment of the present invention;

FIG. 6 shows an example of a neural network activation monitoring scheme;

FIG. 7 shows an example of a neural network output monitoring scheme.

### DETAILED DESCRIPTION

A visual inspection device or system may use different techniques for judging whether a product is defective or not, like for instance one or a combination of the “picture matching” or “parameter matching” processes:
“Picture matching” process: a picture of a product being manufactured is taken; the taken picture is compared with a reference picture of the product; in case the taken picture matches with the reference picture, the product is considered (as a result of the matching) non-defective (or “good”), otherwise defective (or “not good”). The reference picture is for instance a picture of a product that contains no defects, or an acceptable amount and/or type of defects; the matching between the taken picture and the reference picture is determined when there is a given (e.g. predetermined) degree of resemblance between the two pictures. Different techniques are available for establishing the matching, e.g. based on a pixel-by-pixel comparison, etc.
“Parameter matching” process: perform image processing on the taken picture in order to extract certain parameters. The extracted parameters are then compared to reference parameters. In case of matching between extracted parameters and reference parameters, non-defective (“good”) is output, otherwise defective (“not good”) is output. Examples of parameters are color, brightness/contrast, shape, functions of any or of a combination of these, etc. Reference parameters may be determined on the basis of one or more pictures taken on a product considered to be non-defective and/or defective; thus, there is a match of parameters when respective extracted and reference parameters are the same, or different amongst them within a given range.

AI techniques can be applied on inspection devices installed on the manufacturing line, for instance based on one or a combination of the above basic techniques. For example, an AI machine can be trained on a set of taken pictures known to correspond to defective and non-defective products; once the machine is trained, it may be used to inspect a product being manufactured by letting the trained AI machine classify a picture taken of such product on the line. The training can be implemented by using one or a combination of the above methods (though other methods are also possible, independently or in combination). For instance, with regard to the parameter matching process, the AI machine may be trained on the basis of parameters (or features, within a feature space determined for the specific process or task) extracted from a set of available pictures, wherein for each one of these pictures it is known whether it refers to a defective or non-defective product. Once learning is completed, the AI machine is capable of categorizing a newly taken picture into defective and non-defective, by processing the correspondingly extracted parameters using the trained model.

However, such an AI machine is subject to errors, and may thus wrongly classify the product, e.g. as being a false defective (while the actual product is instead good) or a false non-defective (while the actual product in fact is not good). Furthermore and optionally, such AI inspection system may provide a third type of output (beyond the defective and non-defective output), e.g. in those situations wherein the AI machine cannot determine with a certain level of confidence whether the product should be classified as defective or as non-defective. In other words, the third type of output may indicate that the AI machine is not capable of classifying the picture and respective product; in such case, the products may need to undergo manual inspection in order to determine whether it is defective or not. While this third output type may reduce the number of false defective/non-defective classifications (and anyway advantageously assist in the process of determining defective and non-defective items), there are cases wherein the classification cannot be accurately done and/or cannot be timely completed. With AI machine it is generally referred to an entity including a neural network that can be trained on the basis of known items to perform a given task, the task being in the present case inspecting an item; in operation, i.e. when training is completed and the AI machine deployed for actual use, the AI machine is usually capable of performing the given task on an unknown item. By “completed training” it is meant that a sufficient training is performed to start operations; the training may be continued also after operation starts, e.g. when new data become available, and/or periodically, etc.

One way to improve accuracy is to increase the computational power of the AI machine, e.g. by increasing the number of layers of the neural network included in the AI machine, and/or to choose more complex configuration(s) of the neural network. Further, it is conceivable to improve the accuracy of the trained model, e.g. by training the same on a larger data set, possibly combining this with a more performant neural network (i.e. with a neural network having higher computational performance).

The above conceivable AI solution would still be based on a local implementation, thus in line with common practice of performing the inspection on site where the product is being handled so as to ensure minimum delays and latency, being considered crucial factors when performing inspections. For instance, the probability of finding a defective item is relatively smaller than the probability of finding a non-defective item; thus, ensuring minimum delays and latencies in the determination is of particular importance as otherwise the entire process may be substantially delayed; at the same time, it is important also that a determination is correct, e.g. it is important not to miss a defective item.

Based on the above considerations and recognitions, the inventors conceived the idea of distributing the inspection analysis between a local AI machine and a remote AI machine: The local machine can be less computationally performant than the remote machine, such that it can be compact and suitable for installation on site, where (in proximity of) the product is being handled. The involvement of a remote AI, though commonly considered not a suitable solution, turns out in fact to be favorable when used in combination with the local AI machine, since the possible delays and latencies introduced by the remote analysis overcompensate (i.e. are overall smaller than) the delays and latencies caused by the local AI machine inaccuracies or failure to make appropriate determinations. Importantly, this solution allows achieving these effects while maintaining the local inspection device still sufficiently compact and simple in construction and/or installation for use on site. Further to the described local and remote AI machine, it is noted that the remote machine (also later named central neural network) may be omitted according to a variant conceived by the inventors. In fact, the local AI machine can output an indication that a defective or non-defective determination has been reached within a given level of accuracy/confidence, and that e.g. an additional assessment and/or confirmation may be required to more accurately determine whether the item is defective or non-defective.

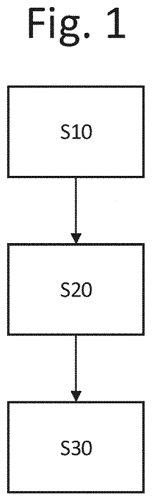

With reference to FIG. 1, a first embodiment is described directed to a method for determining whether an item being processed is defective or non-defective. By defective and non-defective it is meant whether the item respectively complies or not with technical specifications and/or quality criteria for which the item was designed. For instance, the product is defective when its (mechanical, electrical, chemical, and/or optical, etc.) values are outside of their given tolerance and/or when it presents scratch(es) caused by the processing. The method comprises a step S10 of determining, by a local neural network (11), a local classification result based on sensing measurements performed on an item while the item is being processed. The local classification result indicates whether the item is defective or non-defective. The term “local” indicates that the classification result is obtained by the local neural network 11, or in other words by the operation of the local neural network. Local refers to the neural network being placed in proximity of the item being processed. Sensing measurements indicate any measurement results obtained by any sensor coupled to the item (i.e. that can interact or be engaged with the item for measurement purposes, the engagement not limited to a mechanical one), and include by way of example: image data obtained by means of a camera sensor that takes a picture of the item; mechanical measurement results like length data taken e.g. by means of a laser-based measurement device; electric values (like e.g. voltage, current, etc.) measured by respective sensors; density measurements on compositions of the item; measurements showing optical properties of the item taken by respective suitable sensors, etc. The measurements are made on the item being processed, which indicates that the item is being handled within a certain process, and includes by way of example moving and/or processing the item on a manufacturing line, handling the item along transportation for instance at checkpoints in order to verify whether transportation has caused damages, etc. For completeness, it is noted that the local classification result may also indicate that it is not possible determining any of the defective and non-defective states for the item. In one example, therefore, the classification result may output one amongst (i) defective and (ii) non-defective indications for the item; in another example, the classification result may output that a classification into defective or non-defective is (i) possible or (ii) not possible; in another example, the classification result can output one amongst (i) an indication that the item is defective, (ii) an indication that the item is non-defective, and (iii) that a respective determination (of defective/non-defective) is not possible. These examples can be combined, and a device configured to dynamically change amongst such configurations. In the above and below discussions, the determination is illustrated with reference to determining whether an item being processed is defective or non-defective; the same considerations however apply in the case of determining whether an item being processed is present or non-present within a given area; thus, the “whether the item is defective or non-defective” can be understood as also “whether the item is present or not present”. The given area may be: defined in advance (e.g. by means of coordinates); determined for instance on the basis of the sensor(s) performing the sensing measurements (e.g. an area corresponding to the scene that can be captured by a camera; defined in correspondence of a manufacturing component like a robot; corresponding to a range within which a sensor can perform the mentioned sensing measurements; etc. as well as a combination of the above.

At step S20, a confidence index is determined, wherein the confidence index indicates a level of confidence that the local classification result is correct. The level of confidence, as well known in the field of machine learning, expresses the likelihood that a result produced by an AI machine is true or correct, and it can be for instance expressed in percentage (or a value within a range, etc. as examples of the confidence index) of likelihood that the AI estimation corresponds to the actual value. In one illustrative example, a confidence level of 90% may indicate that the local AI machine classification into one of the defective/non-defective results corresponds with a 90% likelihood to the product begin actually defective or respectively non-defective. The same or different threshold levels may be assigned to each of the defective/non-defective determinations. Confidence levels can be obtained in a number of ways as well known, see e.g. in “Distance-based Confidence Score for Neural Network Classifiers”, Amit Mandelbaum and Daphna Weinshall, arXiv:1709.09844v1 [cs.AI] 28 Sep. 2017 (https://arxiv.org/pdf/1709.09844.pdf).

Referring to the above determination that a classification into defective/non-defective is not possible: this may indicate that obtaining such a classification is not feasible, or that such a determination is not reached within a given or predetermined level of confidence. Thus, for example, when neither a defective nor non-defective classification result can be output within respective first and second confidence level thresholds (in one non-limiting example, both thresholds may be the same), the AI machine may output a determination that a classification into defective/non-defective is not possible.

In response to the confidence index being below a given threshold, at step S30 a central classification result is determined by a central neural network 21 on the basis of the sensing measurements, i.e. on the basis of preferably the same information used by the local neural network 11. Similarly to the local classification result, the central classification result indicates whether the item is defective or non-defective. Differently however from the local neural network, the central neural network 21 has more computational resources than the local neural network 11. Thus, central indicates that the processing power is higher than that of the local network, which allows for instance a more complex construction for the central neural network; preferably, the central neural network is remote to the item being processed, i.e. not in proximity of the item being processed and/or of the local neural network. Therefore, the central neural network 21 is more likely capable of determining the defective/non-defective classification result. In other words, the central classification result would be made the final or actual classification result; in case however the local classification result would be above (or, optionally, equal) to the given threshold, then the local classification result becomes the actual classification result, without the need to activate the central neural network. In this way, the additional delay and latency occurring because of the intervention of the local neural network are restricted only to those cases wherein the local central network computational resources are insufficient to provide an accurate result; therefore, the overall system remains highly performant since most of the detections are performed locally, and only when needed the detection is deferred to the central neural network that could anyway obtained the results faster and/or more accurately than other systems. This achieves an overall high performance, since the delays/latencies linked to the activation of the central network overcompensate for the possible latencies/delays caused by the local network failing to determine an accurate result. In one example, the central neural network is represented or includes a computing resource having an AI model, and is connected to a local inspection machine through a communication network, such as internet and/or intranet, and having a larger computing capability than the local machine; further, the central neural network does not need to be necessarily located in the same place as the local machine.

Larger computational resources include for example the case wherein the central neural network 21 is provided with a higher number of layers (e.g. a higher number of middle layers of a neural network; this includes the case where the local neural network has no intermediate layers, and the central network one or more; more in general, as an example, the central neural network has at least one more layer than the local neural network; in other examples, the central neural network has more nodes that a local neural network, this may be combined with higher number of layer(s)) than the local neural network 11, and/or a neural network structure that is more accurate at the expense of its larger/more complex structure, and/or larger memory that makes the neural network capable of handling a larger amount of information, etc.; in addition or in alternative, the larger computational resources may include the case wherein the central neural network 21 is trained on a larger data set and/or is capable of managing a more complex trained model, etc.

Preferably, the inspection method above described comprises the step of outputting a classification result indicating whether the item is at least one amongst defective or non-defective based on the local classification result, when the confidence index indicates a level of confidence that the local classification result is correct, or based on the central classification result otherwise. In other words, the result of the local neural network and/or the result of the central neural network are used to determine the actual classification result, depending on the level of confidence of the classification result determined by the local neural network. In particular, it is conceivable combining the local and central results to further improve accuracy. As evident from the present disclosure, the classification result (being local, central or the final one) may indicate only one amongst defective or non-defective. For instance, the method may be configured to only output a result in correspondence of a non-defective item (or only for a defective item); when no result is provided, it can be implicitly determined that the item is defective (or correspondingly non-defective).

In a variant of the first embodiment, it is foreseen a method comprising steps S10 and S20 as above described, wherein the local neural network is a neural network preferably located in proximity of the item being processed or in proximity of the equipment processing the item or in proximity of the sensors providing the sensing measurements performed on an item; the neural network used in the method of this variant may also be called on premise neural network, and may preferably (but not necessarily) have the same characteristics of the local neural network, in particular the on-premise neural network may be a neural network with limited processing capacities; for instance, it may be a neural network suitable for being executed in a device having limited processing resources (e.g. a client computer or client controller to be installed on a device like an equipment for being placed on a production line), and not a neural network requiring for instance a large server or cloud based execution to operate. The present variant is however not limited to a specific limitation of the computing resources. Both the on-premise and the local neural networks are provided with sensing performed on an item while the item is being processed, which implies that the corresponding sensor is coupled with the item being processed, as also above explained with reference to the local neural network. For simplicity, the present variant is also called on-premise, while the method of the first embodiment above described is also named local/central. In the present variant, at step S30, a notification message is output. The notification message notifies that a classification result (indicating whether the item is defective or non-defective) has a level of confidence below a given level. The notification may optionally include an indication as to whether the item is defective or an indication as to whether the item is non-defective; in this case, the indication about the accuracy preferably refers to the defective or non-defective indication included in the notification. The given level of confidence may be a predetermined level of confidence, which may be set statically or dynamically. Furthermore, the given level of confidence may include a threshold, and preferably may be the same or different threshold of the threshold used by the determining step S20. In other words, at step S30 it is provided an indication that a certain defective or non-defective determination, even if reached, may not be highly or sufficiently accurate; as a consequence, it may be preferably determined that a further assessment and/or confirmation is needed to establish whether the item is defective or non-defective.

Preferably according to the present variant, the notification message is output to a device for notification (or, in other words, for actuating a notification by means of a device) and/or to a device for further processing. Preferably, the notification message may comprise an alarm message and/or a warning message indicating e.g. that a determination could not be performed accurately. Preferably, in alternative or in addition, the notification message may comprise a request to confirm that the determination made by the (on-premise) neural network is correct; such confirmation may be performed by another inspection automatic analysis (e.g. image recognition, measurements and/or tests done on the item, etc.), by a central neural network (as in the local/central case), by an operator, etc. Preferably, the outputting (as e.g. in step S30 of the variant) includes transmitting the notification message to a device, if such a device is not the same as the on-premise device or not in proximity with the inspection device generating the output. Further preferably, the output of a notification refers to the notification being actuated on a device, and may include e.g. notifying an operator that the defective/non-defective determination is not accurate, and/or notifying an application (e.g. monitoring application) that the determination is not accurate. The notification actuated by the device, in particular when addressed to an operator, may be either by means of a display and/or by means of an acoustic signal, and may include other types of notification; examples of such notifications include an alarm message, a warning message, a specific GUI configuration, etc. or any combinations thereof. As above anticipated, the message may be output to a device for further processing; this includes a device for collecting data relating to possible defective/non-defective items (e.g. a yield determining device for determining the yield in handling or processing items), for monitoring the processing of item, for controlling the processing of items (e.g. in order to device whether to stop the processing and/or vary the speed of proceeding items, etc.). In one example, the notification may be a notification to performing a more accurate AI determination, e.g. by means of a remote neural network (in this case, the notification message may include the message sent to the remote neural network).

As apparent from the above, FIG. 1 is herein referred to for describing both the case of the method for the local and central networks and the case of the on-premise neural network. Also, what is explained herein with reference to the first and/or other embodiments, and/or other examples, apply also to the present variant and to other variants as apparent to the skilled person, such that repetitions are avoided.

Optionally, the confidence threshold against which the confidence index is compared may be set so that an expected rate of intervention by the central neural network is within a given intervention threshold. The intervention threshold may be set empirically, and/or on the basis of the characteristics of one or more of the components of the system (like accuracy of measurements from the sensors, level of accuracy of the local and/or central neural network, delays and/or latency of communication between central and local neural network, etc.), and/or a model or function for one or more of the components of the system; furthermore, the intervention threshold may be set dynamically, i.e. changed dynamically, also based on empirical values and/or the characteristics of one or more components of the system and/or a model/function of the same.

Optionally, the confidence index is determined when training the local neural network 11, i.e. during or at the end of the training process a determination is made of the likelihood that the classification result provided by the trained neural network is correct. Optionally, the given threshold is determined empirically, preferably when training the local neural network (i.e. during or at the end of the training process). Empirically means that experiments or tests may be made on the training dataset to determine confidence levels for the local neural network. As said, the given threshold may however be determined also on the basis of the characteristics of one or more of the components of the system, etc.

Two optional schemes of the method are now described, which we name neural network activation monitoring scheme (or activation monitoring, in short), and neural network output monitoring scheme (or output monitoring, in short). These methods may also be combined.

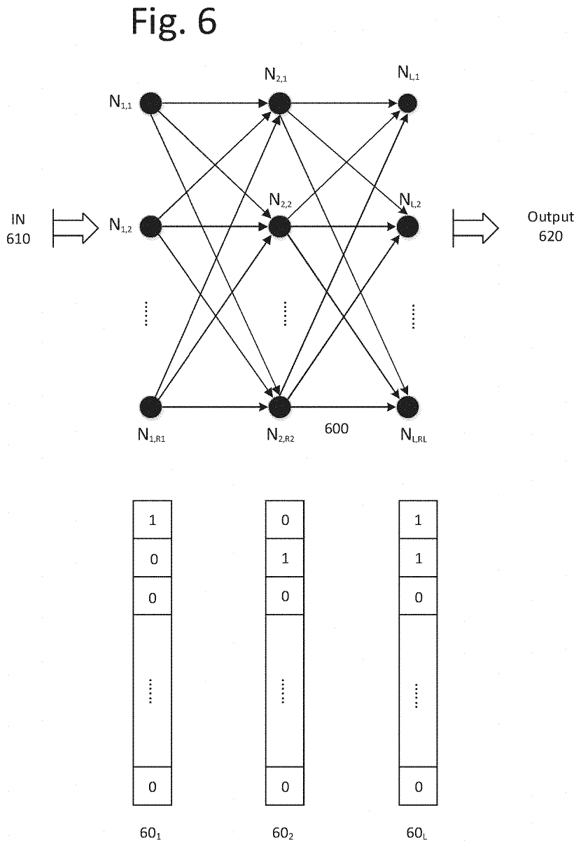

According to the activation monitoring optional scheme, the confidence index may be determined by means of a correlation between an actual activation pattern and a reference activation pattern, wherein the actual activation pattern is the one exhibited by the local neural network 11 when determining the local classification result (e.g. when the network operates on the production line) and the reference activation pattern is the one exhibited by the local neural network while training the same. It is noted that “while training the network” means that the exhibition pattern is the one exhibited when the network is being trained, and that this may be analyzed at the same time as training or after training is completed, in which case the exhibited patterns are stored or at least cashed until they are analyzed. The actual and reference activation patterns preferably refer to one or more nodes of the local neural network. For example: the “activated nodes exhibited when training on defective data” may represent the reference activation pattern in case of defects are present, which we may also call “defective” pattern” or defective reference pattern; during operation, the activated nodes generate an actual activation pattern, which is correlated (e.g. compared) to the defective reference pattern. Each of the actual and reference activation pattern may be represented by a data structure (like a vector, array, linked list, a matrix, etc.) wherein each node is represented by one value (e.g. a bit, a flag, etc.) indicating whether a respective node has been activated or not; one or a combination of the following is possible: all nodes of one layer may be represented in the data structure, all nodes of two or more layers may be represented, at least one node or a plurality of nodes of one or more layers may be represented in the data structure (e.g. in a table like or matrix structure, or other similar representations, which will thus have values like 0 or 1 in correspondence of a node that has not fired or fired—the convention between 0 and 1 may be inverted). In one examples, such data structure contains binary values indicating the firing state of the respective node. In the activation monitoring scheme, the given threshold includes a correlation threshold indicating a predetermined level of correlation, i.e. the pattern exhibited while in use may be exactly the same as the pattern exhibited during training, or different according to a predetermined level/rule (e.g. a given number of nodes may differ in the pattern, or their belonging to certain layers, etc.; examples will be given later with reference to FIG. 6). For instance, let us assume that during training a set of activated patterns is detected in correspondence of a defective result, and let us name each pattern of the set as Pd1, Pd2, . . . , Pdi, . . . Pdn, wherein Pdi includes only the nodes that are activated when a defective result is output (e.g. for Pdi: N1Pdi, N2Pdi, . . . , NnPdi; thus, NjPdi indicates that node Nj of pattern Pdi has been activated when producing a defective result). During operation, i.e. when the network is run to produce a result classification for a measured item, let us assume that defective is output by the local neural network; before concluding that defective is the classification result, it is compared (here, one example of the correlation) whether the nodes activated during the actual classification process are comprised in one of the patterns Pd1, . . . Pdn. If yes, then “defective” is confirmed as the actual classification result; if not, then either “non-defective” is output, or an indication that it is not possible to determine defective/nom-defective is output. Thus, by means of the activation pattern correlation it is possible to increase the accuracy of determining a defective or non-defective prediction. The above is based on the inventor's recognition that when determining a defective state, there is a sort of bias in the nodes that tend to be activated, resulting in a relatively sparse number of activation patterns when considered relatively to the space represented by all hypothetical node combinations. Similar considerations apply to the case of determining a non-defective state.

In the output monitoring scheme, the confidence index is determined by correlating at least one actual feature vector with at least one respective reference feature vector. The actual reference vector is obtained by the local neural network 11 while determining the classification result on an item being processed, i.e. when the neural network is in operation after training is completed. The reference feature vector is instead obtained by the local neural network 11 while training the same (with regard to “while determining”, see the above activation monitoring case). The (actual and/or reference) feature vector obtained by the local neural network preferably includes a vector containing feature parameters obtained by (e.g. as output from) at least one node of one or more layers of the local neural network; in other words, the vector contains values corresponding to the output of at least one node of one or more layers of the local neural network. Such vector thus typically contains values representing at least certain features that the network predicts; typically, such vector contains non-binary values, since each value is a representation of a feature element. For instance, in one example, the feature vector may include values corresponding to the output of all nodes of the final layer; in this case, the feature vector will represent the (actual or reference) features estimation as produced by the entire network. In another example, the vector contains values corresponding to the output of all nodes (or the output of all nodes) from one (or more) intermediate layer(s) are taken, such that the vector can be seen as an intermediate (actual or reference) estimation of the network. In a further example, the vector contains values corresponding to the output of a subset (i.e. one or more nodes, but less than all the nodes of a given layer) of the nodes of one or more layers of the local neural network; also in this case, the (actual or reference) vector will represent an intermediate estimation produced by the network. In the previous examples, coefficients may be associated to nodes and/or layers when determining the reference or actual vector (these coefficients may be determined in the training phase, on the basis of the type of neural network, etc.). The previous examples can be combined with each other in any way. One advantage of an intermediate estimation is that a decision can be taken early on, without waiting for the entire network output to be processed, thus reducing the delay needed to decide whether to invoke the central neural network. Thus, by using an intermediate estimation (i.e. be taking one or more nodes that are not the final output of the local neural network) reduces the time needed to invoke the central neural network, and thus improves in reducing the overall latency. Which layers and/or which nodes and/or how many nodes in a given layer are selected for obtaining the (actual or reference) vector may be determined empirically in order to obtain a tradeoff between accuracy of determining the confidence index, and reduced latency of the system, may be determined during training, or on the basis of specific rules depending on the type of network implemented. The feature vector, especially when it refers to the non-final output of the neural network, can thus also be said to represent a sort of compressed node information with regard to features such as number of activated nodes (and the feature respectively produced by the node) in a certain layer of the local neural network or collection of local outputs of the nodes in a certain layer of the network. Preferably, the nodes determined (or selected) for the reference feature vector are the same as the nodes determined (or selected) for the actual vector; the nodes may ne however different, in particular the number of nodes of the actual vector may be less than the nodes of the reference network. Optionally, the architecture of the central neural network may be such that it includes some or all of the layers of the local neural network (e.g. the complexity of the central network comes with the layer(s) “downstream towards the output”): In this case, the intermediate result may be sent to the central neural network, which can thus start processing starting from such intermediate estimation rather than from the beginning, thus further reducing overall latencies. Similar to the above case, the inventors have recognized that a defective output (and similarly, a non-defective output) results in a non-dense (e.g. sparse) number of feature vectors in the feature space. Optionally, the determined correlation between actual and reference feature vectors is within a given range or tolerance or rule. Thus, by verifying that the actual feature pattern correlates to a reference feature pattern for a defective output, it is possible confirming that the actual classification result is defective; similar considerations apply to the case of non-defective.

In other words, with reference to the optional activation and output monitoring schemes, it is possible to obtain a first level confidence index and a second level confidence index; the first level confidence index may be the one of the classification result output by the neural network (based e.g. on known techniques or on empirical rules or model); the second level confidence index may be obtained by means of the activation and/or output monitoring schemes, to verify that the first level confidence index is correct. The second level confidence index (i.e. one or both of the above schemes) may come into play always, or only in certain circumstances, e.g. when the first level confidence index is not above a certain threshold. When the second level confidence case is always used, then the first level index may also be omitted (i.e. the prior art techniques or an empirical method/model may be omitted, and the confidence index calculated on the basis of the activation and/or output monitoring schemes). As said, however, applying one or both schemes is optional.

Optionally, in the method herein described, the central neural network includes a neural network as that of the local neural network; the local neural network sends to the central neural network a feature vector obtained by the local neural network, and the central neural network starts processing on the basis of the feature vector received by the local neural network.

For example, all nodes of all layers of the local neural network are also found also in the central local network. The output (feature vector) produced by the local neural network is sent to the central neural network, which thus starts processing from the layer immediately following the layer corresponding to the output layer of the local neural network. Similarly, if the feature vector is one obtained from one intermediate layer (or nodes) and sent to the central neural network, then the central neural network starts processing from the corresponding layer (or nodes). See also the above examples on intermediate estimates, which represent intermediate feature vectors produced by the local neural network.

We note that what has been said above equally applies to the below further embodiments and examples unless otherwise stated, as well as vice-versa, so that repetitions are avoided.

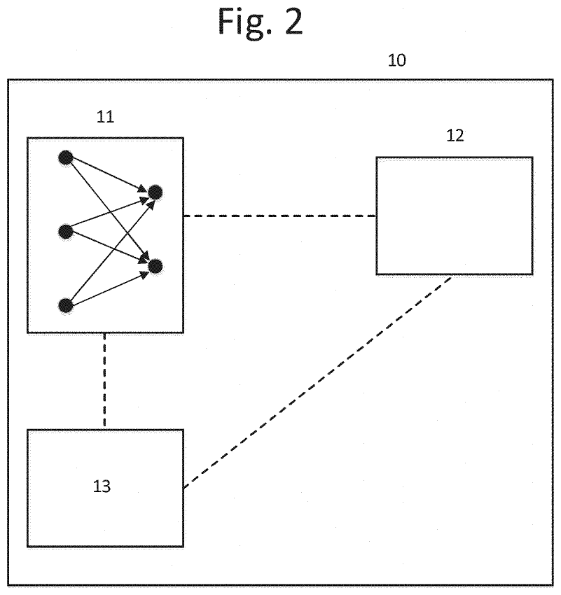

With reference to FIG. 2, a second embodiment will now be described directed to an inspection device 10 for determining whether an item being processed is defective or non-defective, the device 10 including a local neural network 11, a processor 12 and an output section 13. The local neural network 11 is configured to determine, on the basis of sensing measurements performed on an item while the item is being processed, a local classification result indicating whether the item is defective or non-defective. The processor 12 is configured to determine a confidence index which indicates a level of confidence that the local classification result is correct, i.e. that the possibly determined defective or non-defective state likely corresponds to the item being actually defective or, respectively, non-defective. The output section 13 is configured to output, in response to the confidence index being below a given (predetermined) threshold, a central classification notification that notifies that the indication as to whether the item being processed is defective or non-defective is to be performed by a central neural network. The local neural network 11 has less computational resources than the central neural network 21. In other words, the central classification notification flags that a central classification result, and not a local classification result, is to be preferably obtained, and that the output of the central neural network 21 may thus to be regarded as the actual (or final) classification result. In further other words, the notification indicates that the local result may not be accurate, and that a central result may be more suitable and may thus override the local result. The central classification notification may be represented by a flag, for instance by one bit, indicating whether or not the central activation network has to be activated to classify the resultant based on the sensing measurements; the notification may then be read or received by another device, which may command the central neural network to perform the classification. Optionally, the central classification notification may include a command or instruction sent directly to the central neural network, or to another device, to obtain such central classification result. It is noted that “local” and “central” in local classification result and central classification result refer to the classification result being respectively obtained by the local or central neural networks.

Optionally, the central classification notification includes a request to determine the central classification result by a central neural network, i.e. a request that the classification result is to be determined by a central neural network. In this case, the output section 13 may be configured to send the request to the central neural network 21 or to a central inspection device 20 including the central neural network 21; however, the notification may be sent to another network device, like for instance an administration device, which then instructs a suitable neural network that is more powerful than the local neural network (e.g. in a cloud environment, the central neural network is implemented in the cloud; optionally, a cloud device may direct the task to one amongst a plurality of neural networks deployed in the cloud).

In a variant of the second embodiment, it is foreseen an inspection device comprising a determining unit 11 and a processor as described above with reference to FIG. 2. The output section 13 of the present variant is configured to output, in response to the confidence index being below a given threshold, a notification message notifying that a result indicating whether an item being processed is defective or non-defective has a level of confidence below a given level. The present variant of the second embodiment may thus be named on-premise (similarly and correspondingly to the variant of the first embodiment), while the second embodiment may be named local/central. Preferably, in the present variant, the output section (13) is further configured to output the notification message to a device for notification and/or to a device for further processing. As apparent from the above, FIG. 2 is herein referred to for describing both the case of the device of the second embodiment and of the variant of the second embodiment. Also, what is explained in the present document with reference to the first and/or second and/or other embodiments, and/or other examples, and/or the first variant of the first embodiment apply also to the present variant of the second embodiment and to other variants as apparent to the skilled person, such that repetitions are avoided.

Optionally, the confidence index is determined when training the local neural network 11, and the given threshold is determined empirically, preferably when training the local neural network 11.

Optionally, according to a neural network activation monitoring scheme, the confidence index is determined by correlating an (actual) activation pattern exhibited by a plurality of nodes of the local neural network 11 when determining the local classification result with a reference activation pattern exhibited by the corresponding plurality of nodes of the local neural network 11 while training the same local neural network 11. The given threshold includes a correlation threshold that indicates a predetermined level of correlation between the actual and reference activation buttons. The “actual” in “actual activation pattern” refers to the neural network being in operation while the item for which classification is to be obtained is processed.

Optionally, in the neural network output monitoring scheme, the confidence index is determined by correlating at least one feature vector obtained by the local neural network 11 while determining the classification result with at least a respective reference feature vector obtained by the local neural network 11 while training the same local neural network 11. In other words, and as said above with reference to the first embodiment, it is determined whether one or more feature vectors produced during actual classification are the same, or within given ranges or tolerances or rules, as reference feature vectors obtained during training.

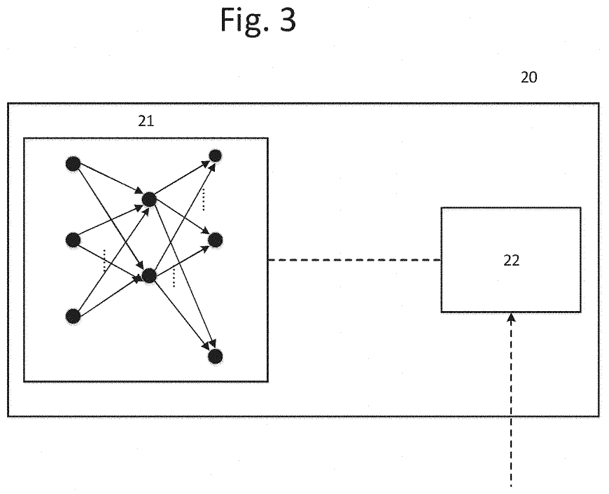

With reference to FIG. 3, a third embodiment is described directed to an inspection device 20 for determining whether an item being processed is defective or non-defective. The device 20 includes a central neural network 21 and a receiver 22. The central neural network 21 is configured to determine, on the basis of sensing measurements performed on an item while the item is being processed, a classification result that indicates whether the item is defective or non-defective. The receiver 22 is configured to receive an instruction to perform the central classification. The instruction indicates that a local neural network 11 has previously determined (or attempted to determine) a classification result on the basis of the same sensing measurements, however reaching a confidence level that is below a given threshold. The local neural network 11 has less computational resources than the central neural network 21. Therefore, the instruction indicate that a more accurate classification process has to be performed by the central neural network 21 than the classification process attempted by the local neural network.

Optionally, the central inspection device 20 is configured to operate the central neural network 21 by using more computational resources than those available at the local neural network.

Optionally, the confidence index is determined when training the local neural network 11 and the given threshold is determined empirically, preferably when training the local neural network 11.

Optionally, according to a neural network activation monitoring scheme, the confidence index is determined by correlating an actual activation pattern and a reference activation pattern. The actual activation pattern is the one exhibited by a plurality of nodes of the local neural network 11 when determining the local classification result, while the reference activation pattern is exhibited by the plurality of nodes of the local neural network 11 while training the same local neural network 11. The given threshold includes a correlation threshold indicating a predetermined level of correlation between the two patterns.

Optionally, according to a neural network output monitoring scheme, the confidence index is determined by correlating at least one feature vector obtained by the local neural network 11 while determining the classification result with at least a respective reference feature vector obtained by the local neural network 11 while the same is trained.

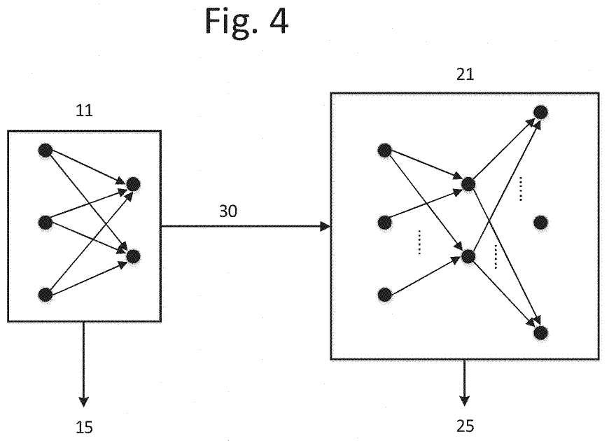

With reference to FIG. 4, a fourth embodiment is now described directed to an inspection system for determining, on the basis of sensing measurements performed on an item while the item is being processed, whether the item is defective or non-defective by using at least one of the local neural network 11 and a central neural network 21. The local neural network has less computational resources than the central neural network. The local and central neural networks are capable of wireless and/or wired communication across a wireless and/or wired interconnecting network. A local neural network is configured to determine whether the item is defective or non-defective; furthermore, the system is capable of determining a local confidence index indicating a level of confidence that the local classification result is correct. Then, in response to a determination that a local confidence index is not above a predetermined confidence level (i.e. the result is likely not correct), the central neural network determines the central classification result indicating whether the obtained sensing measurements represent a defective item or a non-defective item. In other words, if the classification result reached locally by neural network 11 is believed not to be sufficiently accurate, then the classification result is obtained by the central neural network. Therefore, the central classification result is made the classification result of the system.

Optionally, the local neural network 11 can be part of or itself represent a local inspection device; similarly, the central neural network 21 can be part or itself represent a central inspection device. The local neural network is typically located in proximity of the item being processed and therefore to the sensor(s) performing measurements on the item to be processed. The central local network may be remote to the local neural network, and connected over a network.

Optionally, in the above system, the confidence index is determined when training the local neural network 11 and the given threshold is determined empirically, preferably when training the local neural network.

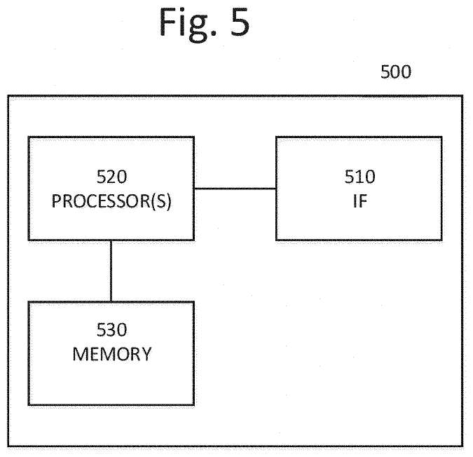

With reference to FIG. 5, a fifth embodiment will be described directed to a computer program comprising instructions configured to execute, when the instructions are executed on a computer, any or a combination of the steps of the method and the variants thereof as described above, e.g. with reference to the first embodiment. FIG. 5 illustrates a block diagram exemplifying a computer (500) capable of running the aforesaid program. In particular, the computer (500) comprises a memory (530) for storing the program instructions and/or the data necessary for its execution, a processor (520) for carrying out the instructions themselves and an input/output interface (510).

In another non-illustrated embodiment, it is provided a medium for supporting a computer program configured to perform, when the program is run on a computer, one or a combination of the steps according to the method described above, e.g. with reference to the first embodiment. Examples of a medium are a static and/or dynamic memory, a fixed disk or any other medium such as a CD, DVD or Blue Ray. The medium also comprises a means capable of supporting a signal representing the instructions, including a means of cable transmission (ethernet, optical, etc.) or wireless transmission (cellular, satellite, digital terrestrial, etc.).

According to an already mentioned example, a sensor may be represented by a camera, and the sensing measurements may correspond to image data obtained by means of a camera. For example, the camera may take a picture of an item (e.g. a product) while the same is on the production line. In another example, the camera may take a picture of an item while the same is being moved or transiting from one location points to another location point.

According to another example, the sensor may be represented by a voltage and/or current sensor suitable for making respective measurements on an electronic product while the same is being produced, or transferred from one point to the point. Other examples are represented by sensors measuring the length and/or width and/or height of an item, optical properties of the item, mechanical and/or chemical properties of the item, etc.

An example of a neural network activation monitoring scheme is explained now with reference to FIGS. 6, depicting a neural network having L layers, each layer i having a number NRi of nodes. The nodes of layer i are numbered N_{i,1}, N_{i,2} . . . N_{i,Ri}. Let us assume that, during training, it is found that a defective product (e.g. a picture known to correspond to a defective product) leads to activation of the nodes such that in each layer only the first and/or second nodes are activated while the rest of the nodes of each such layers are not activated; this is represented graphically in the lower part of FIG. 6, wherein for each layer an array is given, and wherein only the first two positions are different than zero (1 representing activation, 0 representing non activation). This may represent a reference pattern of nodes activation when determining a defective item, and may thus be associated to an indication (one example of the second level confidence index, see above) of the item being defective. During operation, i.e. after training and when the neural network is deployed for classifying results, it is observed how the nodes are activated, further to observing the output of the network; the pattern of nodes detected during operation is also herein named actual pattern. If during operation the neural network (a) produces a classification result indicating that the product is non-defective, and at the same time (b) an actual pattern is detected wherein only one of the first two nodes are activated, the system may determine that the classification result is not correct since the activation pattern does not correspond to the reference activation pattern. In this example, a pattern is considered in view of all layers and all nodes of each layer (e.g. 60₁, 60₂ to 60_{L} all make one pattern); however, the pattern may be defined for only one or more layers, and for only one or more nodes for each such layers (e.g. one single or any combinations amongst 60₁, 60₂ to 60_{L}). Also, more patterns (and not only one pattern) may be defined, all corresponding to a defective item; it has been found, in fact, that amongst all possible combinations of nodes activation, only a limited subset corresponds to a given classification result. Furthermore, a specific pattern may be associated not only to the general classification result, but also to one of its subcategories; for instance, the pattern above discussed and illustrated in FIG. 6 may be associated to a defect represented by a scratch on the item. The above discussion refers to the classification result being “defective”, the same considerations applies to the case “non-defective”. Evidently, the level of correlation between the reference and actual patterns can be defined depending on circumstances, for instance by comparing each node of the reference pattern with each node of the actual pattern, and concluding that there is correlation when there is an exact match or when at least some of the activated nodes are found in both of the reference and action patterns. When there is no correlation, the system determined that the output result is likely incorrect, i.e. that the local network is not capable of making an (accurate) determination. Thus, the central neural network intervenes in determining the classification result. The correlation can be defined mathematically, or by means of a rule (e.g. if-then based, etc.).

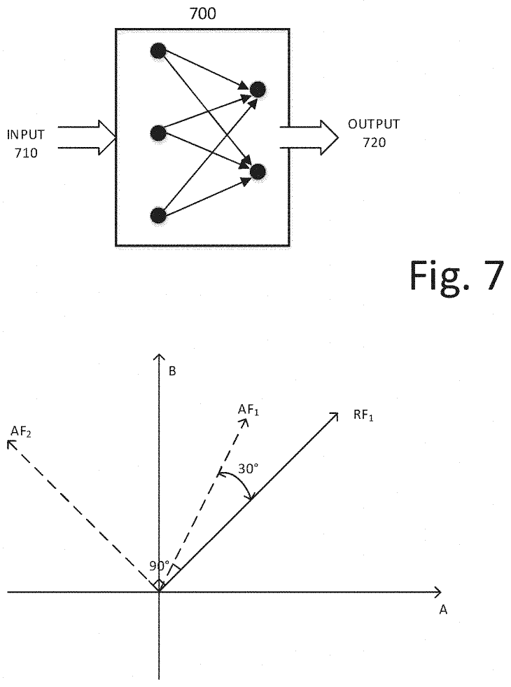

An example of a neural network output monitoring scheme is explained now with reference to FIG. 7, depicting a neural network 700 that provides as output 720 data representing a feature; the output feature is the result of the network 700 being excited by certain sensing measurements given as input 710. The network 700 may be an example of the local neural network above discussed. For simplicity, let us assume that the feature is this example is a vector having only two components (A, B) such that it can be graphically represented in a two-axis coordinate system. Let us assume that during training it is observed that a non-defective item is always or predominantly characterized by a reference feature vector RF1 as depicted in FIG. 7; in other words, RF1 indicates a feature extracted by the neural network 700 when excited—during training—by data representing a known defective product. Let us now assume that during operation, i.e. once training is completed and the network deployed for classifying items, the network 700 analyzing a first item I1 outputs (a) “defective” as classification result and (b) AF1 as actual feature vector for the first item I1. When classifying a second item I2, the network 700 still outputs (a) “defective” but then (b′) AF2 as the actual vector extracted for the second item I2. If the vector product between reference feature and actual feature (RF1×AF1) is within a given threshold, then the classification result is confirmed to be correct; if not, the result is not confirmed to be correct. Visually, in this simplified example, the threshold may be represented by an angle and/or by the length of the vector. For simplicity, let us assume that the output classification result is confirmed if AFi is within a 45° rotation of RF1. By referring to the values of FIG. 7, it can be seen that AF1 has a 30° rotation over RF1, i.e. is within the 45° threshold, such that item I1 is confirmed as “defective”, since the feature monitoring confirms the classification result given at output 720. However, AF2 is 90° rotated relative to RF1, such that the system determines that “defective” is likely incorrect, i.e. that the local network is not able to classify the item. Thus, the central neural network intervenes to correct the classification. The example is illustrative, and in fact multiple RFs may be present, and each vector may have only value or more than the two values (i.e. the two values herein discussed is only for illustrative purposes). The invention still applies, since it has been found that during classification the number of reference vector is relatively small compared to all possible vector representation in the given space.

A neural network as herein described, being e.g. a local or a central neural network, can be implemented by means of hardware and/or software. In particular, the central neural network may be implemented over distributed hardware and/or software resources (e.g. in a cloud) also remotely connected to each other and each remotely connected to the local neural network. It is conceivable to also implement the local neural network in a distributed manner; if this is made, however, its level of distributed implementation is lower than the one of the central neural network in that the processing delays and/or latencies of the local neural network are smaller than respective IDs of the central neural network.

In the present description, reference has been made to neural networks, or units (like sensor(s), memory, processor, etc.), etc. The invention is not limited to the specific networks and/or units therein described, and it in fact equally applies to respective means; thus, the neural network, memory, processor, sensor etc. may be substituted by neural network means, memory means, processing means, sensing means, etc., respectively. These network and/or units (or respective means) can be implemented as a distinct/self-contained units/entities or as distributed units/entities (i.e. implemented through a number of components connected to one another, whether physically near or remote); these, be they concentrated or distributed, can further be implemented through hardware, software or a combination thereof.

Many of the embodiments and examples have been explained with reference to steps of methods or processes. However, what has been described can also be implemented in a program to be run on a computing entity (also distributed) or an entity whose means are suitably configured. As illustrated above, the entity can be implemented in a single device, via HW/SW or a combination thereof, or in multiple interconnected units or devices (likewise HW, SW or a combination thereof). Naturally, the description set forth hereinabove concerning embodiments and examples that apply the principles recognized by the inventors is provided solely by way of example of these principles and therefore it should not be understood as a limitation of the scope of the invention claimed herein.

1. An inspection method for determining whether an item being processed is defective or non-defective, the method including the steps of:
determining, by a local neural network and on the basis of sensing measurements performed on an item while the item is being processed, a local classification result indicating whether the item is defective or non-defective;
determining a confidence index indicating a level of confidence that the local classification result is correct;
in response to the confidence index being below a given threshold, determining, by a central neural network and on the basis of the sensing measurements, a central classification result indicating whether the item is defective or non-defective, wherein the local neural network has less computational resources than the central neural network.

2. The method according to claim 1, wherein
the confidence index is determined when training the local neural network and wherein the given threshold is determined empirically, when training the local neural network.

3. The method according to claim 1, wherein
the confidence index is determined by correlating an actual activation pattern exhibited by a plurality of nodes of the local neural network when determining the local classification result with a reference activation pattern exhibited by said plurality of nodes of the local neural network while training the local neural network, and wherein
the given threshold includes a correlation threshold indicating a predetermined level of correlation.

4. The method according to claim 1, wherein
the confidence index is determined by correlating at least one feature vector obtained by the local neural network while determining the classification result with at least one respective reference feature vector obtained by the local neural network while training the local neural network, wherein the one feature vector obtained by the local neural network includes a vector containing feature parameters obtained by at least one node of one or more layers of the local neural network.

5. The method according to claim 1, wherein
the central neural network includes a neural network as that of the local neural network,
the local neural network sends to the central neural network a feature vector obtained by the local neural network, and
the central neural network starts processing on the basis of the feature vector received by the local neural network.

6. An inspection device for determining whether an item being processed is defective or non-defective, the local inspection device comprising:
a local neural network configured to determine, on the basis of sensing measurements performed on an item while the item is being processed, a local classification result indicating whether the item is defective or non-defective;
a processor configured to determine a confidence index indicating a level of confidence that the local classification result is correct;
an output section configured to output, in response to the confidence index being below a given threshold, a central classification notification notifying that a result indicating whether an item being processed is defective or non-defective is to be performed by a central neural network, wherein the local neural network has less computational resources than the central neural network.

7. The inspection device of claim 6, wherein
the central classification notification includes a request to determine the central classification result by a central neural network, and wherein the output section is configured to send the request to a central inspection device including the central neural network.

8. The inspection device according to claim 6, wherein
the confidence index is determined when training the local neural network and wherein the given threshold is determined empirically, when training the local neural network.

9. The inspection device according to claim 6, wherein
the confidence index is determined by correlating an actual activation pattern exhibited by a plurality of nodes of the local neural network when determining the local classification result with a reference activation pattern exhibited by said plurality of nodes of the local neural network while training the local neural network, and wherein
the given threshold includes a correlation threshold indicating a predetermined level of correlation.

10. The inspection device according to claim 6, wherein
the confidence index is determined by correlating at least one feature vector obtained by the local neural network while determining the classification result with at least a respective reference feature vector obtained by the local neural network while training the local neural network.

11. An inspection device for determining whether an item being processed is defective or non-defective, the inspection device including:
a central neural network configured to determine, on the basis of sensing measurements performed on an item while the item is being processed, a classification result indicating whether the item is defective or non-defective,
a receiver configured to receive an instruction to perform the central classification, the instruction indicating that a local neural network determined a classification result on the basis of the sensing measurements with a confidence level below a given threshold, wherein the local neural network has less computational resources than the central neural network.

12. The inspection device of claim 11, wherein
the central inspection device is configured to operate the central neural network by using more computational resources than those available at the local neural network.

13. The inspection device of claim 11, wherein
the confidence index is determined when training the local neural network and wherein the given threshold is determined empirically, when training the local neural network.

14. The inspection device of claim 11, wherein
the confidence index is determined by correlating an activation pattern exhibited by a plurality of nodes of the local neural network when determining the local classification result with a reference activation pattern exhibited by said plurality of nodes of the local neural network while training the local neural network, and wherein
the given threshold includes a correlation threshold indicating a predetermined level of correlation.

15. The inspection device of claim 11, wherein
the confidence index is determined by correlating at least one feature vector obtained by the local neural network while determining the classification result with at least a respective reference feature vector obtained by the local neural network while training the local neural network.

16. An inspection system for determining, on the basis of sensing measurements performed on an item while the item is being processed, whether the item is defective or non-defective by using at least one of a local neural network and a central neural network, wherein the local neural network has less computational resources than the central neural network, wherein
in response to a determination that a local confidence index is not above a predetermined confidence level, the local confidence index indicating a level of confidence that the local classification result is correct, the central neural network is configured to determine a central classification result indicating whether the obtained sensing measurements represent a defective item or a non-defective item, and wherein
the central classification result is made the classification result of the system.

17. The inspection system of claim 16, wherein
the confidence index is determined when training the local neural network and wherein the given threshold is determined empirically, when training the local neural network.

18. The inspection system of claim 16, wherein
the confidence index is determined by correlating an activation pattern exhibited by a plurality of nodes of the local neural network when determining the local classification result with a reference activation pattern exhibited by said plurality of nodes of the local neural network while training the local neural network, and wherein
the given threshold includes a correlation threshold indicating a predetermined level of correlation.

19. The inspection system of claim 16, wherein
the confidence index is determined by correlating at least one feature vector obtained by the local neural network while determining the classification result with at least a respective reference feature vector obtained by the local neural network while training the local neural network.

20. An inspection method for determining whether an item being processed is defective or non-defective, the method including the steps of:
determining, by a neural network and on the basis of sensing measurements performed on an item while the item is being processed, a classification result indicating whether the item is defective or non-defective;
determining a confidence index indicating a level of confidence that the classification result is correct;
in response to the confidence index being below a given threshold, outputting a notification message notifying that a classification result indicating whether the item is defective or non-defective has a level of confidence below a given level.

21. The method of claim 20, wherein the notification message is output to a device for notification and/or to a device for further processing.

22. The method according to claim 20, wherein
the confidence index is determined when training the neural network and wherein the given threshold is determined empirically, when training the neural network.

23. The method according to claim 20, wherein
the confidence index is determined by correlating an actual activation pattern exhibited by a plurality of nodes of the neural network when determining the classification result with a reference activation pattern exhibited by said plurality of nodes of the neural network while training the neural network, and wherein
the given threshold includes a correlation threshold indicating a predetermined level of correlation.

24. The method according to claim 20, wherein
the confidence index is determined by correlating at least one feature vector obtained by the neural network while determining the classification result with at least one respective reference feature vector obtained by the neural network while training the neural network, wherein the one feature vector obtained by the neural network includes a vector containing feature parameters obtained by at least one node of one or more layers of the neural network.

25. An inspection device for determining whether an item being processed is defective or non-defective, the inspection device comprising:
a neural network configured to determine, on the basis of sensing measurements performed on an item while the item is being processed, a classification result indicating whether the item is defective or non-defective;
a processor configured to determine a confidence index indicating a level of confidence that the classification result is correct;
an output section configured to output, in response to the confidence index being below a given threshold, a notification message notifying that a result indicating whether an item being processed is defective or non-defective has a level of confidence below a given level.

26. The inspection device of claim 25, wherein the output section is further configured to output the notification message to a device for notification and/or to a device for further processing.

27. The inspection device according to claim 25, wherein
the confidence index is determined when training the neural network and wherein the given threshold is determined empirically, when training the neural network.

28. The inspection device according to claim 25, wherein
the confidence index is determined by correlating an actual activation pattern exhibited by a plurality of nodes of the neural network when determining the classification result with a reference activation pattern exhibited by said plurality of nodes of the neural network while training the neural network, and wherein
the given threshold includes a correlation threshold indicating a predetermined level of correlation.

29. The inspection device according to claim 25, wherein
the confidence index is determined by correlating at least one feature vector obtained by the neural network while determining the classification result with at least a respective reference feature vector obtained by the neural network while training the neural network.

30. A non-transitory computer-readable medium storing a computer program comprising instructions configured to execute, when said instructions are executed on a computer, the steps of claim 1.

31. (canceled)
